(19) United States
(12) Patent Application Publication
(10) Pub. No.: US 2013/0330830 A1
(43) Pub. Date: Dec. 12, 2013

(54) METHOD FOR FLUORESCENCE DETECTION

(71) Applicant: GeneReach Biotechnology Corp., Taichung (TW)

(72) Inventors: Ping-Hua TENG, Taichung (TW); Ching-Ko LIN, Taichung (TW); Hung-Ming CHEN, Taichung (TW)

(21) Appl. No.: 13/906,359

(22) Filed: May 31, 2013

(30) Foreign Application Priority Data
Jun. 6, 2012 (TW) 101120271

(51) Int. Cl. G01N 21/64

(52) U.S. Cl. CPC G01N 21/6486
USPC 436/86; 436/172; 436/94; 702/19

(57) ABSTRACT

A method for fluorescence detection is provided and includes mixing a fluorescence detecting reagent into a sample, placing the sample into a sample tray, where the sample tray includes at least a row of blank slots and at least a row of sampling slots. Then, exposing the sample tray to a background light, and obtaining a grayscale background image of the sample tray.

### RELATED APPLICATIONS

The application claims priority to Taiwan Application Serial Number 101120271 filed Jun. 6, 2012, which is herein incorporated by reference.

### BACKGROUND

1. Field of Invention

The present invention relates to a method for analyzing biomolecules. More particularly, the present invention relates to a method for fluorescence detection of biomolecule samples.

2. Description of Related Art

Fluorescence detection manners have been widely applied to nucleic acids or protein analysis. While emitting a light with a proper wavelength to a sample having fluorescence properties, the sample may absorb the energy of the light and then electrons of the sample molecule will be excited from a ground electronic state to an excited electronic state. After a very short duration, the sample molecule will then drop down to the ground electronic state and lights will be emitted due to the sudden change of the energy level. Additionally, while the sample is, or combined with, fluorescent substances, these fluorescent substances may emit fluorescence signals. Accordingly, it can be determined that whether the sample is combined with fluorescent substances or whether the sample combined with the fluorescent substances exists by observing the fluorescence signal of the sample.

Conventional fluorescence detectors usually include a light source, a photodetector, and a light condensing device. While a sample is exposed to the light emitted from the light source, the sample absorbs the light energy and emits fluorescence signals. Nevertheless, because that the fluorescence signal is weak and is very likely to be interfered by other light sources such as the emitting light source, the fluorescence signal needs to be condensed by the light condensing device in order to be detected by the photodetector. The to aforementioned light condensing device usually includes a couple of lenses, reflection lenses, and emission filters, and the light path of the light condensing device is complex with poor accuracy. Plus, the light source is, generally, mercury lamps, xenon lamps, or halogen lamps, despite the relatively wide wavelength coverage of these light sources, the specific wavelength of the light source needs to be selected and filtered according to different fluorescent substances such as fluorescent indicators. Accordingly, different optical filters are needed for filtering these specific wavelengths, and these optical filters, however, are costly, and the fluorescence signals emitted therefrom are weak. Subsequently, while the fluorescence signal is detected by the photodetector, the fluorescence signal will be transferred into an electric current signal, and this electric current signal will then be transferred into an analog electric potential signal through a trans-impedance amplifier. Afterwards, this analog electric potential signal will be transferred into a digital electric potential via an analog-to-digital converter. Till then, the experimental data is finally able to be collected. In short, the trivial components and ways used in conventional processes are costly, inefficient, and miscellaneous.

The common techniques of detecting fluorescence signal is to directly receive and read the fluorescence signal of a target, and while the fluorescence signal exceeds a specific value, it tells that the fluorescence signal occurs However, the accuracy and stability of this fluorescence receiving method is easily to be effected under various circumstances. Moreover, conventional fluorescence detecting apparatuses are usually bulky so that they are quite inconvenient to bring along. Consequently, the samples to be analyzed have to be brought back to the lab in order to perform fluorescence analysis via the fluorescence detecting apparatuses, and it is quite time consuming.

### SUMMARY

According to one embodiment of the present disclosure, a method for fluorescence detection includes mixing a fluorescence detecting reagent into a sample, placing the sample into a sample tray, where the sample tray includes at least a row of blank slots and at least a row of sampling slots, exposing the sample tray to a background light, and obtaining a grayscale background image of the sample tray.

### BRIEF DESCRIPTION OF THE DRAWINGS

The invention can be more fully understood by reading the following detailed description of the embodiment, with reference made to the accompanying drawings as follows:

FIG. 1 is a flow chart illustrating a method for fluorescence detection according to one embodiment of the present disclosure;

FIG. 2 is a flow chart illustrating a method for fluorescence detection according to one embodiment of the present disclosure;

FIG. 3 is a flow chart illustrating the read-out process of FIG. 2;

FIG. 4 is a flow chart illustrating the read-out process of FIG. 2 according to another embodiment of the present disclosure;

FIG. 5 is a schematic diagram illustrating a fluorescence detecting device according to one embodiment of the present disclosure; and

FIG. 6 is a schematic diagram illustrating numerous grayscale sample images of the sample tray obtained using numerous differences of exposure durations.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

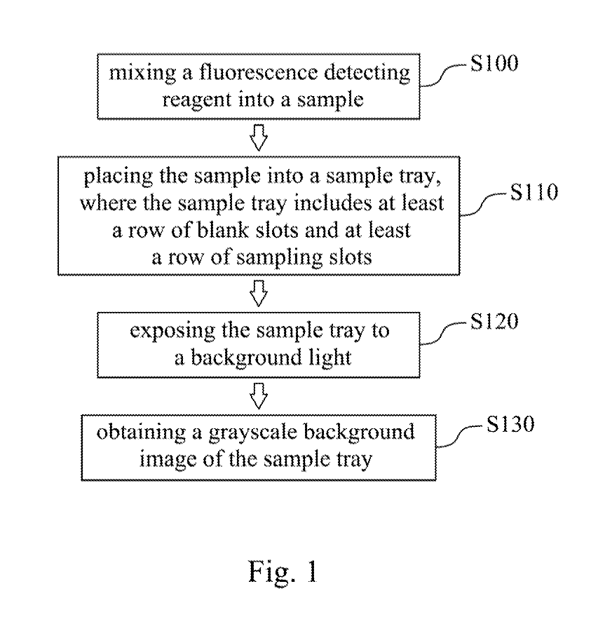

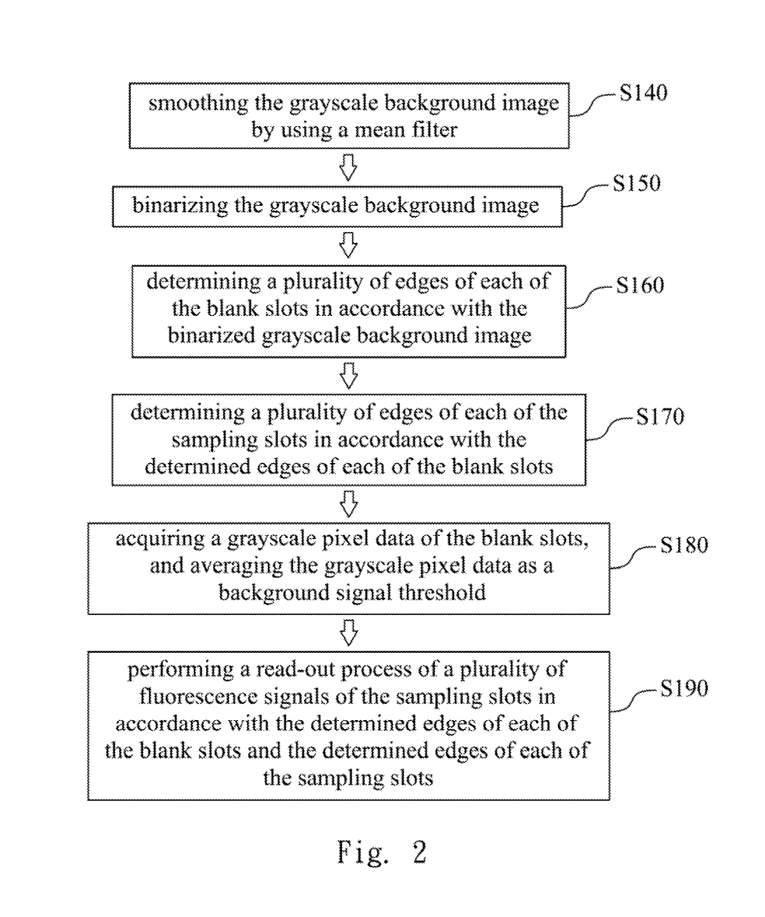

FIG. 1 is a flow chart illustrating a method for fluorescence detection according to one embodiment of the present disclosure, and the method includes the following steps. Step S100, mixing a fluorescence detecting reagent into a sample. Step S110, placing the sample into a sample tray, where the sample tray includes at least a row of blank slots and at least a row of sampling slots. Step S120, exposing the sample tray to a background light. Step S130, obtaining a grayscale background image of the sample tray. Moreover, the method illustrated in FIG. 1 further includes the following steps illustrated in FIG. 2. Step S140, smoothing the grayscale background image by using a mean filter. Step S150, binarizing the grayscale background image. Step S160 determining a plurality of edges of each of the blank slots in accordance with the binarized grayscale background image. Step S170, determining a plurality of edges of each of the sampling slots in accordance with the determined edges of each of the blank slots. Step 180, acquiring a grayscale pixel data of the blank slots, and averaging the grayscale pixel data as a background signal threshold. Step 190, performing a read-out process of a plurality of fluorescence signals of the sampling slots in accordance with the determined edges of each of the blank slots and the determined edges of each of the sampling slots.

The aforementioned sample can be chemicals which are capable of fluorescence emission such as protein molecules or nucleic acids. The method of the present disclosure can be widely applied to various experimental techniques, such as tryptophan fluorescence spectrometry, nanodrop, or other kinds of experimental assays required for detecting fluorescence signals of the samples.

Further, according to step S130, the grayscale image is obtained by analyzing the luminance of each pixels of a visible image generated of part of the background light transmitted through the blank slots. Moreover, smoothing the grayscale background image by using a mean filter in step S140 is to divide the grayscale background image into numerous portions consisted of 16 pixels (4×4), and then to utilize the grayscale values of these portions for completing this smoothing process. The image binarization technique in step S150 is a well-Known technique so that it is no need and will not be covered again here.

When the background light is emitted, the background light may be transmitted through the blank slots, and then the grayscale background image can be projected and binarized into a binary background image. By referring to the position of the white color part of the binary background image, which represents the edges of the blank slot, the corresponding position of the blank slot can be determined. Plus, because that the corresponding position between the sample slot and the blank slot is already known, the edge of the sample slot in the grayscale background image can be calculated and defined in accordance with the corresponding position of the edge of the blank slot.

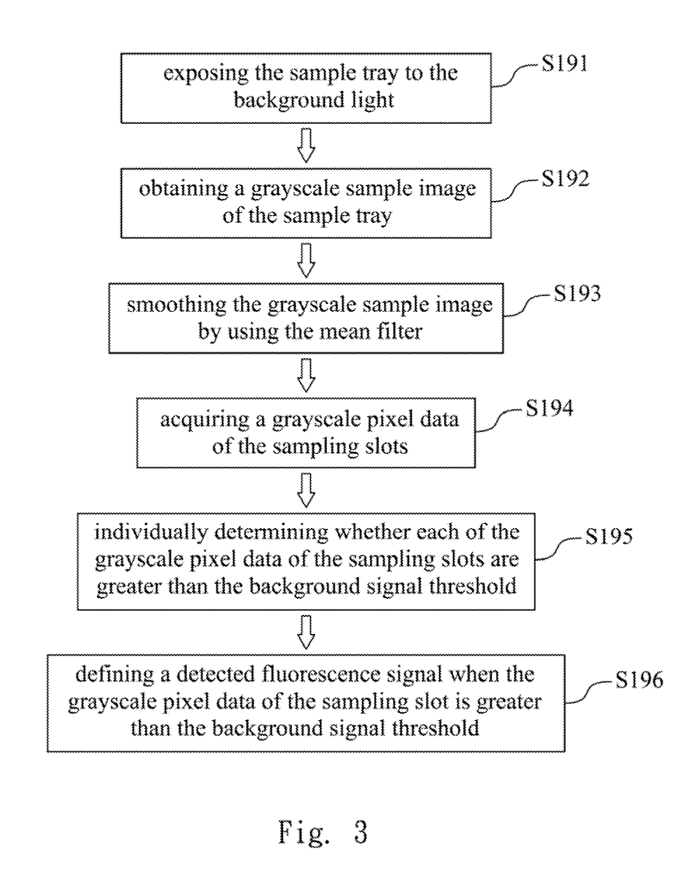

FIG. 3 is a flow chart illustrating the read-out process of FIG. 2. The read-out process of step 190 includes the following steps. Step S191, exposing the sample tray to the background light. Step S192, obtaining a grayscale sample image of the sample tray. Step S193, smoothing the grayscale sample image by using the mean filter. Step S194, acquiring a grayscale pixel data of the sampling slots. Step S195, individually determining whether each of the grayscale pixel data of the sampling slots are greater than the background signal threshold. Step S196, defining a detected fluorescence signal when the grayscale pixel data of the sampling slot is greater than the background signal threshold.

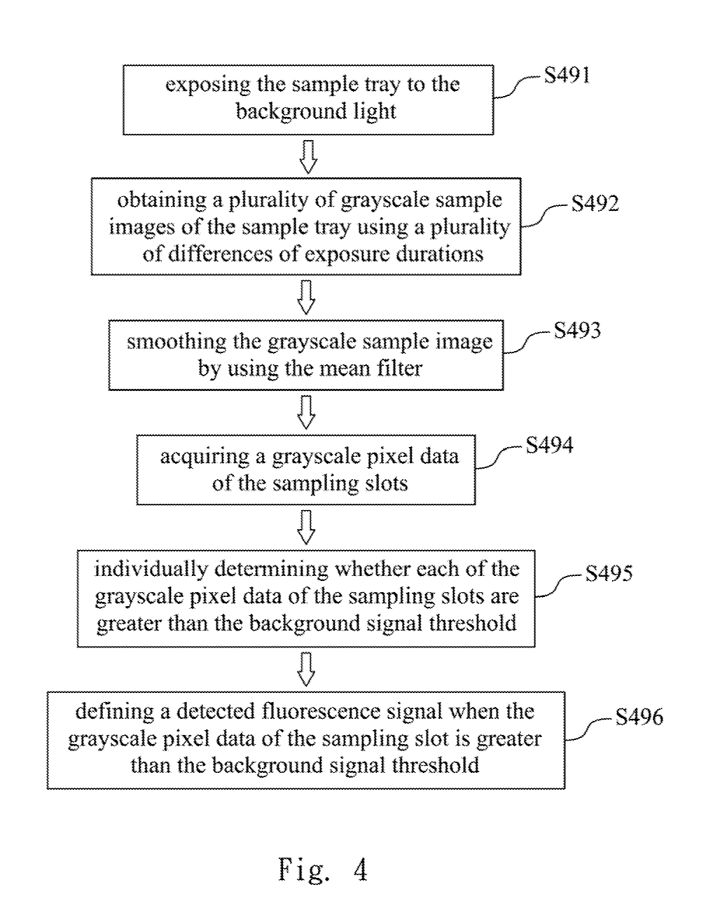

FIG. 4 is a flow chart illustrating the read-out process of FIG. 2 according to another embodiment of the present disclosure. The read-out process includes the following steps. Step S491, exposing the sample tray to the background light. Step S492, obtaining a plurality of grayscale sample images of the sample tray using a plurality of differences of exposure durations. Step S493, smoothing the grayscale sample image by using the mean filter. Step S494, acquiring a grayscale pixel data of the sampling slots. Step S495, individually determining whether each of the grayscale pixel data of the sampling slots are greater than the background signal threshold. Step S496, defining a detected fluorescence signal when the grayscale pixel data of the sampling slot is greater than the background signal threshold.

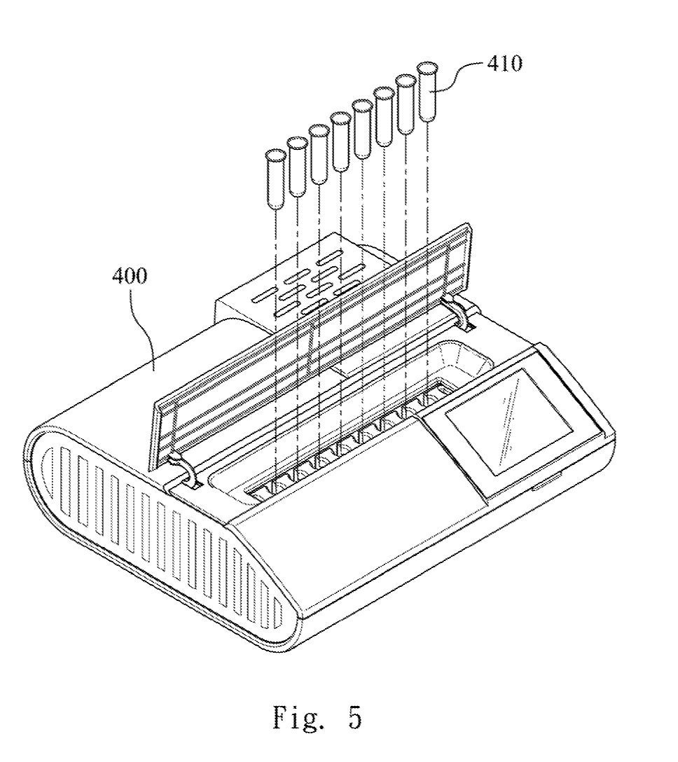

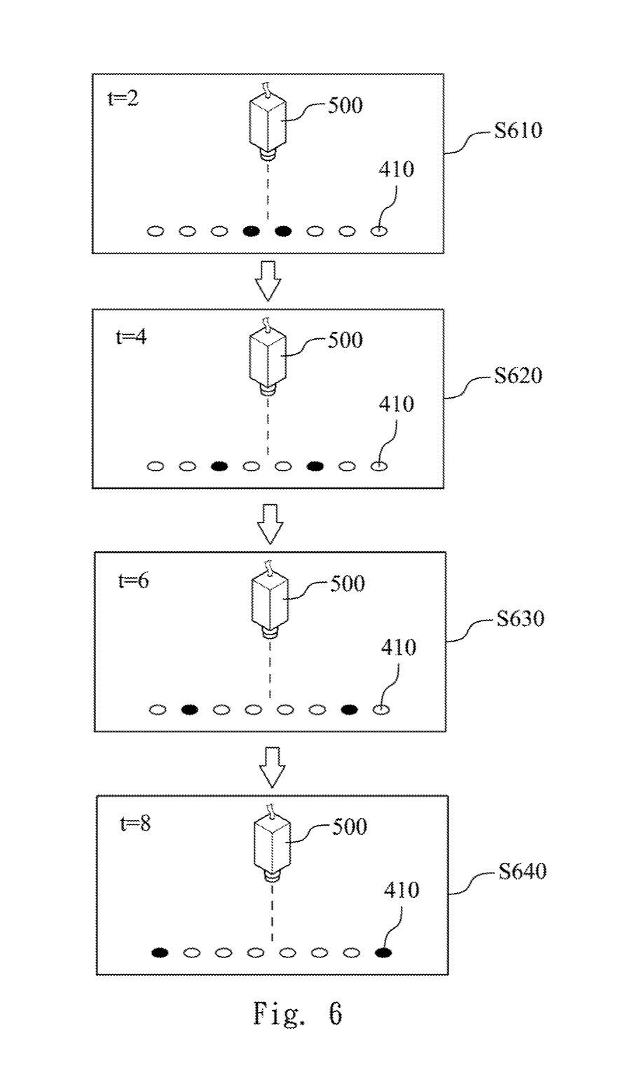

FIG. 5 is a schematic diagram illustrating a fluorescence detecting device 400 according to one embodiment of the present disclosure, and FIG. 6 is a schematic diagram illustrating numerous grayscale sample images of the sample tray obtained using numerous differences of exposure durations, in which FIG. 6 provides detailed steps of the process of how those numerous grayscale sample images are collected. Referring to step S610 of FIG. 6, a grayscale sample image of the sample tray is captured and obtained by a photodetector 500, where the exposure duration for capturing, the grayscale sample image by the photodetector 500 is 2 seconds. Then, step 620 is performed, where another grayscale sample image of the sample tray is captured and obtained by a photodetector 500, and the exposure duration for capturing the grayscale sample image by the photodetector 500 is 4 seconds. Step 630, another grayscale sample image of the sample tray is captured and obtained by a photodetector 500, and the exposure duration for capturing the grayscale sample image by the photodetector 500 is 6 seconds. Finally, step 640, another grayscale sample image of the sample tray is captured and obtained by a photodetector 500, and the exposure duration for capturing the grayscale sample image by the photodetector 500 is 8 seconds. Referring through step S610 to step S640, the sample slots 410 covered by the black spots means that their corresponding fluorescence signals are greater than a background signal threshold, which means a fluorescence signal of the sample slot is detected. Further, the exposure durations of each sample slots 410 for exceeding the background signal threshold extend and vary upon the relative distance between the sample slots 410 and the photodetector 500, that is, when the relative distance between the sample slot 410 and the photodetector 500 is longer, the exposure duration of the sample slot 410 for exceeding the background signal threshold would be longer. By using this principle, experimental deviations due to the relative distances between the sample slot 410 and the photodetector 500 could be diminished. However, when the exposure duration is too long, the accuracy of the grayscale sample images of the sample slots 410 which is closer to the photodetector 500 would be effected. The grayscale sample images of the sample slots 410 of step 610 to step 640 are then being smoothed with the mean filter in order to obtain a more accurate and consistent data of the sample slots 410.

Because that the corresponding positions of the sample slots are defined during the process of acquiring the background signal threshold, the grayscale sample images of the sample slots are no need to be binarized; the fluorescence signal of each sample slots can be defined as detected by comparing the background signal threshold and the grayscale pixel data of the sampling slots according to their grayscale sample images.

Besides, in addition to the aforementioned steps of the read-out process, the following steps may be further included. Acquiring the grayscale pixel data of the sample slots according to the grayscale sample image. Determining whether the fluorescence signal is detected according to the grayscale background image of the blank slots, and suspending the experimental procedure when the fluorescence signal is not detected, which is defined as an error. That is, when the fluorescence signals of all of the sample slots are not detected, the read-out process of the fluorescence signals can be temporarily suspended so that the related experimental personnel can fix the error immediately in order to continue on the unfinished experiments.

According to the techniques of acquiring the grayscale background to images or the grayscale sample images, these grayscale images can be captured by using a photodetector, where the photodetector can be Complementary Metal Oxide Semiconductor (CMOS) or Charge Coupled Device (CCD). Moreover, in order to keep the initial measured fluorescence signals of the grayscale sample images having different exposure durations more consistent, the exposure duration are determined by a computer program, where the exposure duration shortens as the fluorescence intensity increases.

In addition, each of the sample slots is covered by an optical filter for blocking out lights with undesired wavelengths.

Furthermore, the background light can be emitted from an LED or a laser source, so that while emitting fluorescence from different kinds of samples, the background lights with proper wavelengths can be selected without using excitation filters for filtering the lights with desired wavelengths.

By utilizing the smoothing process and the binarizing process of the grayscale images of the present disclosure, the fluorescence signal detecting process can be simpler and the background signal threshold can be slightly adjusted for different experimental purposes. In addition, the grayscale sample images of the sample slots can be obtained by using differences of exposure durations to enhance the consistencies and accuracies of those.

According to another embodiment of the present disclosure, a method for fluorescence detection is provided and includes the following steps. Firstly, placing the sample into a sample tray, where the sample tray includes at least a row of blank slots and at least a row of sampling slots. Then, exposing the sample tray to a background light, and obtaining a grayscale background image of the sample tray. Afterwards, smoothing the grayscale background image by to using a mean filter, binarizing the grayscale background image, determining a plurality of edges of each of the blank slots in accordance with the binarized grayscale background image, determining a plurality of edges of each of the sampling slots in accordance with the determined edges of each of the blank slots, acquiring a grayscale pixel data of the blank slots, and averaging the grayscale pixel data as a background signal threshold. Next, performing a read-out process of a plurality of fluorescence signals of the sampling slots in accordance with the edges determined of each of the blank slots and the edges determined of each of the sampling slots.

According to one embodiment of the present disclosure, the aforementioned positioning process includes the following steps. Placing a sample container into the sample slot, where the coordinate of the sample slot can be positioned by analyzing the lights transmitted through the sample contained in the sample container using a computer program. This analysis manner is not limited to image analysis nor photoelectric analysis. The coordinates of the sample slots can also be defined by another computer program before fluorescence detection is started.

Furthermore, the positioning process may also be performed by using the sample container covered by an optical cutting filter or a polarizing filter, afterwards, the coordinates of the sample slots can be defined using another computer program for analyzing the lights transmitted through the optical cutting filter or the polarizing filter. This analysis manner is not limited to image analysis nor photoelectric analysis. What is more, the positioning process may also be assisted by using at least two external light sources to assist the positioning process. These light sources may be disposed at both sides of each of the sample slots respectively, and the coordinates of the sample slots may be defined by using the computer program for analyzing the exposing position of the sample slots by these lights.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the invention. In view of the foregoing, it is intended that the present disclosure cover modifications and variations of this invention provided they fall within the scope of the following claims.

What is claimed is:

1. A method for fluorescence detection, comprising:
mixing a fluorescence detecting reagent into a sample;
placing the sample into a sample tray, wherein the sample tray comprises at least a row of blank slots and at least a row of sampling slots;
exposing the sample tray to a background light; and
obtaining a grayscale background image of the sample tray.

2. The method according to claim 1, further comprising:
smoothing the grayscale background image by using a mean filter;
binarizing the grayscale background image;
determining a plurality of edges of each of the blank slots in accordance with the binarized grayscale background image;
determining a plurality of edges of each of the sampling slots in accordance with the determined edges of each of the blank slots;
acquiring a grayscale pixel data of the blank slots, and averaging the grayscale pixel data as a background signal threshold; and
performing a read-out process of a plurality of fluorescence signals of the sampling slots in accordance with the determined edges of each of the blank slots and the determined edges of each of the sampling slots.

3. The method according to claim 2, wherein the read-out process further comprises:
exposing the sample tray to the background light;
obtaining a grayscale sample image of the sample tray;
smoothing the grayscale sample image by using the mean filter;
acquiring a grayscale pixel data of the sampling slots;
individually determining whether each of the grayscale pixel data of the sampling slots are greater than the background signal threshold; and
defining a detected fluorescence signal when the grayscale pixel data of the sampling slot is greater than the background signal threshold.

4. The method according to claim 2, wherein the step of obtaining the grayscale background image of the sample tray is performed by using a photodetector, wherein the photodetector is Complementary Metal Oxide Semiconductor (CMOS) or Charge Coupled Device (CCD).

5. The method according to claim 2, herein each of the blank slots is covered by an optical filter.

6. The method according to claim 2, wherein the background light is emitted from an LED or a laser source.

7. The method according to claim 1, further comprising:
smoothing the grayscale background image by using a mean filter;
binarizing the grayscale background image;
determining a plurality of edges of each of the blank slots in accordance with the binarized grayscale background image;
determining a plurality of edges of each of the sampling slots in accordance with the determined edges of each of the blank slots;
acquiring a grayscale pixel data of the blank slots, and averaging the grayscale pixel data as a background signal threshold;
performing a read-out process of a plurality of fluorescence signals of the sampling slots in accordance with the edges determined of each of the blank slots and the edges determined of each of the sampling slots;
exposing the sample tray to the background light;
obtaining a plurality of grayscale sample images of the sample tray using a plurality of differences of exposure durations;
smoothing the grayscale sample image by using the mean filter;
acquiring a grayscale pixel data of the sampling slots;
individually determining whether each of the grayscale pixel data of the sampling slots are greater than the background signal threshold; and
defining a detected fluorescence signal when the grayscale pixel data of the sampling slot is greater than the background signal threshold.

8. The method according to claim 7, wherein the step of obtaining the grayscale background image of the sample tray is performed by using a photodetector, wherein the photodetector is Complementary Metal Oxide Semiconductor (CMOS) or Charge Coupled Device (CCD).

9. The method according to claim 7, wherein the differences of the exposure duration are determined by a computer program, and the exposure duration shortens as the fluorescence intensity reduces.

10. The method according to claim 7, wherein each of the sampling slots is covered by an optical filter.

11. The method according to claim 7, wherein the background light is emitted from an LED or a laser source.

12. The method according to claim 1, further comprising:
performing a positioning process for determining a corresponding position of the sampling slots;
smoothing the grayscale background image by using a mean filter;
binarizing the grayscale background image;
determining a plurality of edges of each of the blank slots in accordance with the binarized grayscale background image;
determining a plurality of edges of each of the sampling slots in accordance with the determined edges of each of the blank slots;
acquiring a grayscale pixel data of the blank slots, and averaging the grayscale pixel data as a background signal threshold; and
performing a read-out process of a plurality of fluorescence signals of the sampling slots in accordance with the determined edges of each of the blank slots and the determined edges of each of the sampling slots.

13. The method according to claim 12, wherein the read-out process further comprises:
exposing the sample tray to the background light;
obtaining a plurality of grayscale sample images of the sample tray using a plurality of differences of exposure durations;
smoothing the grayscale sample image by using the mean filter;
acquiring a grayscale pixel data of the sampling slots;
individually determining whether each of the grayscale pixel data of the sampling slots are greater than the background signal threshold; and
defining a detected fluorescence signal when the grayscale pixel data of the sampling slot is greater than the background signal threshold.

14. The method according to claim 12, wherein the step of obtaining the grayscale background image of the sample tray is performed by using a photodetector, wherein the photodetector is Complementary Metal Oxide Semiconductor (CMOS) or Charge Coupled Device (CCD).

15. The method according to claim 12, wherein each of the sampling slots is covered by an optical filter.

16. The method according to claim 12, wherein the background light is emitted from an LED or a laser source.

17. The method according to claim 12, wherein the positioning process is performed directly by using a light transmitted from a sample container, wherein the sample container is where the fluorescence detecting reagent and the sample are mixed.

18. The method according to claim 12, wherein the positioning process is performed by using a coordinate of the sample slot before placing the sample therein.

19. The method according to claim 12, wherein the positioning process is performed by using a sample container covered by an optical cutting filter or a polarizing filter, wherein the sample container is where the fluorescence detecting reagent and the sample are mixed.

20. The method according to claim 12, wherein the positioning process is assisted by using at least two external light sources.
